(19) United States
(12) Patent Application Publication
(10) Pub. No.: US 2005/0092879 A1
(43) Pub. Date: May 5, 2005

(54) STACKABLE FURNITURE WITH REMOVABLE LEG STRETCHER ASSEMBLY

(75) Inventor: Robert Mainville, El Monte, CA (US)

Correspondence Address: LOTT & FRIEDLAND, P.A., P.O. BOX 141098, CORAL GABLES, FL, 33114-1098, US

(73) Assignee: BROWN JORDAN INTERNATIONAL, INC., Pompano Beach, FL (US)

(21) Appl. No.: 10/904,135

(22) Filed: Oct. 26, 2004

Related U.S. Application Data
(60) Provisional application No. 60/515,275, filed on Oct. 29, 2003.

(51) Int. Cl. F16M 11/16

(52) U.S. Cl. 248/188

(57) ABSTRACT

A chair or table with a hub-and-spoke or other interior member stretcher design wherein the chair or table consists of a chair or table portion and a detachable stretcher assembly; wherein the stretcher assembly consists of stretchers in a hub-and spoke or other interior member configuration, leg extension portions at the ends of the stretchers and longitudinal openings through the leg extensions; and wherein the stretcher assembly is easily attachable to the chair or table portion by means of machined inserts secured to the inside of each leg of the chair or table portion, flanged glides designed to fit through the longitudinal openings of the leg extensions, and screw fastener which secure the flanged glides and leg extensions to the machined inserts.

### CLAIM OF PRIORITY

This application claims priority to Provisional U.S. Application Ser. No. 60/515,275, filed on Oct. 29, 2003, the contents of which are incorporated herein by reference.

### FIELD OF THE INVENTION

This invention relates generally to indoor and outdoor furniture, and more particularly, to a chair, table or other form of legged furniture with a removable leg stretcher assembly to facilitate stacking and packaging of multiple articles.

### BACKGROUND OF THE INVENTION

Manufacturers of low-priced furniture are constantly attempting to create designs that achieve the look of more expensive furniture without a significant increase in manufacturing costs. One way to do this is to incorporate in their products elements and features traditionally found in more expensive designs. These elements and features can be aesthetic, functional, or both, and are generally associated with expensive furniture because their inclusion in less-expensive designs would lead to increased manufacturing, shipping, or design costs.

One such element which is specifically applicable to chair and table designs is the leg stretcher. Leg stretchers are elongated elements that connect the lower end of all legs in a chair or table together in order to provide added stability and durability to the chair or table.

It is well know to furniture designers that one of the primary causes for structural failure of chairs and tables without stretchers is leg joint stress that occurs as a result of the repeated loading and unloading the furniture undergoes in daily use. The leg joint is the joint formed between the horizontal load bearing surface of the chair or table and the vertical leg elements. Under load, the lower (or “free”) ends of the chair or table legs have a tendency to spread apart. That is, the free leg ends have a tendency to pivot outward about the leg joint. Repeated loading and unloading cycles have a tendency to loosen the leg joints. Under excessive loading the leg joint may be stressed beyond its maximum capacity and break causing the chair or table to collapse.

The primary function of a leg stretcher is to counteract the spreading force on the free leg ends by connecting the leg ends to each other and providing an alternate path for stress to be transmitted and dissipated away from the leg joint. In one popular type of leg stretcher design, hereinafter referred to as a “hub-and-spoke” design, each leg has one end of a stretcher attached near its free end and the other end attached to a “hub” point which is located internally to all the legs. It is usual, although not necessary, for all stretchers to be of nearly equal length and for the center of the “hub” to be nearly equidistant from the free ends of all the legs.

Thus, using as an example a four-legged chair, when viewed from above or below, a hub-and-spoke stretcher design would appear as a “cross” or an “X”. In a five-legged table, the hub-and-spoke stretcher design would appear, as the name implies, as a central “hub” with five “spokes” stretching outwardly. It is not unusual, for structural or aesthetic reasons, for the stretchers in a hub-and-spoke design to not lie in the same plane. That is, the hub-and-spoke design may be convex or concave (if the stretchers are curved) or pyramidal (if the stretchers are straight).

The hub-and-spoke stretcher design is popular because it is generally the most structurally efficient stretcher design. This is so because the force imparted by each stretcher on the free end of its attached leg is generally in a direction which is directly opposite to the “spreading” force imparted by the load on the chair or table. In addition, the “spreading” force for each leg will generally counteract or balance the “spreading” force in one or more geometrically opposite legs. This results in an overall balancing of forces that efficiently utilizes the load transmission structure of each stretcher.

The use of a hub-and-spoke stretcher design in chairs or tables, however, has one major disadvantage. Generally speaking, chairs and tables are designed so that when not in use, in storage, or during transportation, they can be stacked on top of each other by laying the bottom of one load supporting structure (i.e., the seating surface or the table top surface) over the top of another. By successively stacking chairs or tables, much space can be saved. For example, a properly designed set of 20 chairs in a stacked configuration should not occupy much more volume that 2 chairs would occupy unstacked.

There are many advantages to designing furniture so that it is stackable. For example, stackable furniture is much less expensive to ship since it occupies significantly less cargo space. Stackable furniture is more useful as it does not occupy as much space when not in use and can be easily stored. Also, consumers are more likely to purchase larger quantities of stackable furniture since storage space in a home is scarce and a consumer is very unlikely to purchase more furniture than he/she can store even if there is a need for such furniture.

Unfortunately, a chair or table with a permanent hub-and-spoke leg stretcher design is not stackable. Similarly, other types of leg stretcher designs having interior members (hereinafter “interior member stretcher designs”) that prevent chairs or tables from being stackable. This is so because the stretchers prevent the bottoms and tops of the multiple seats or table tops from coming together in a stacked configuration.

Therefore, there exists a need in the art for a stackable chair or table with a hub-and-spoke or other interior member stretcher design. There also exists a need in the art for a chair or table with a hub-and-spoke or other interior member stretcher design that is efficiently transportable. There also exists a need in the art for a chair or table with a hub-and-spoke or other interior member stretcher design that is easily and efficiently storable.

### SUMMARY OF THE INVENTION

The present invention solves significant problems in the art by providing a legged furniture article, comprising a base surface, a plurality of legs interconnected with said base surface and extending downwardly therefrom and a removable leg stretcher assembly; wherein said removable leg stretcher assembly comprises a plurality of elongated stretchers each having a distal and a proximal end, a plurality of leg extensions, wherein each of said leg extensions is connected to the distal end of a corresponding one of said stretchers, a hub point connecting the proximal ends of said stretchers, means for removably attaching said leg stretcher assembly to the legs of said legged furniture article; wherein said means for removably attaching said leg stretcher assembly to the legs of said legged furniture article comprise leg extension openings traversing the entire length of each of said leg extensions, threaded screw-receiving attachment means (comprising threaded holes or machined inserts) located on the floor-facing surface of each of said legged furniture article legs, glides, wherein said glides are adapted so as to fit inside each of said leg extension openings but prevented from completely being inserted into said leg extension openings, unthreaded screw holes traversing the entire length of each of said glides and, screw fasteners, wherein each of said screw fasteners is adapted to be inserted through said unthreaded screw holes and engage said threaded screw-receiving attachment means; and wherein the number of said stretchers and said leg extensions is the same as the number of said plurality of legs in said legged furniture article.

In another aspect of the present invention significant problems in the art are solved by providing a removable leg stretcher assembly for use with legged furniture, comprising a plurality of elongated stretchers each having a distal and a proximal end, plurality of leg extensions, wherein each of said leg extensions is connected to the distal end of a corresponding one of said stretchers, a hub point connecting the proximal ends of said stretchers, and means for removably attaching said leg stretcher assembly to the legs of said legged furniture; wherein said means for removably attaching said leg stretcher assembly to the legs of said legged furniture comprise leg extension openings traversing the entire length of each of said leg extensions, threaded screw-receiving attachment means (comprising threaded holes or machined inserts) located on the floor-facing surface of each of said furniture legs, glides, wherein said glides are adapted so as to fit inside each of said leg extension openings but prevented from completely being inserted into said leg extension openings, unthreaded screw holes traversing the entire length of each of said glides, and, screw fasteners, wherein each of said screw fasteners is adapted to be inserted through said unthreaded screw holes and engage said threaded screw-receiving attachment means; and wherein the number of said stretchers and said leg extensions is the same as the number of legs in said legged furniture.

Accordingly, an object of the present invention is to provide a chair or table with a hub-and-spoke or other interior member stretcher design that avoids the disadvantages of the prior art.

Another object of the present invention is to provide a chair or table with a hub-and-spoke or other interior member stretcher design that is easily removable so that the chair or table becomes stackable.

Yet another object of the present invention is to provide a chair or table with a hub-and-spoke or other interior member stretcher design that is efficiently transportable.

Yet another object of the present invention is to provide a chair or table with a hub-and-spoke or other interior member stretcher design that is easily and efficiently storable.

Yet another object of the present invention is to provide a chair or table with a hub-and-spoke or other interior member stretcher design wherein the chair or table consists of a chair or table portion and a detachable stretcher assembly; wherein the stretcher assembly consists of stretchers in a hub-and spoke or other interior member configuration, leg extension portions at the ends of the stretchers and longitudinal openings through the leg extensions; and wherein the stretcher assembly is easily attachable to the chair or table portion by means of machined inserts secured to the inside of each leg of the chair or table portion, flanged glides designed to fit through the longitudinal openings of the leg extensions, and screw fastener which secure the flanged glides and leg extensions to the machined inserts.

The novel features which are considered characteristic of the present invention are set forth in the instant specification. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

FIG. 1A is an illustration of a chair embodiment of the present invention in which the chair portion and stretcher assembly portions are detached.

FIG. 1B is an illustration of a fully assembled chair embodiment of the present invention.

FIG. 2 is an illustration of a top view of a stretcher assembly for use with a chair embodiment of the present invention.

FIG. 3 is a partial exploded isometric view of the stretcher assembly and chair portion of a chair embodiment of the present invention showing a chair leg, leg extension, stretcher, machined fastener, flanged glide and screw fastener.

FIG. 4 is a partial isometric view of the stretcher assembly and chair portion of a chair embodiment of the present invention showing a chair leg, leg extension, stretcher, machined fastener, flanged glide and screw fastener.

FIG. 5 is a partial front view of the stretcher assembly and chair portion of a chair embodiment of the present invention showing a chair leg, leg extension, stretcher, machined fastener, flanged glide and screw fastener in an assembled condition.

FIG. 6 is a cross section of the view shown in FIG. 5 showing a chair leg, leg extension, stretcher, machined fastener, flanged glide and screw fastener in an assembled condition.

### DETAILED DESCRIPTION OF THE PREFERRED EMBODIMENT

The following describes the preferred embodiment of a chair in accordance with the present invention. It will be understood by those reasonably skilled in the relevant art that an embodiment of a table, a chaise lounge, an ottoman, or any other legged furniture, in accordance with the present invention is substantially similar to that disclosed in the preferred embodiment and is encompassed within the spirit of the instant disclosure.

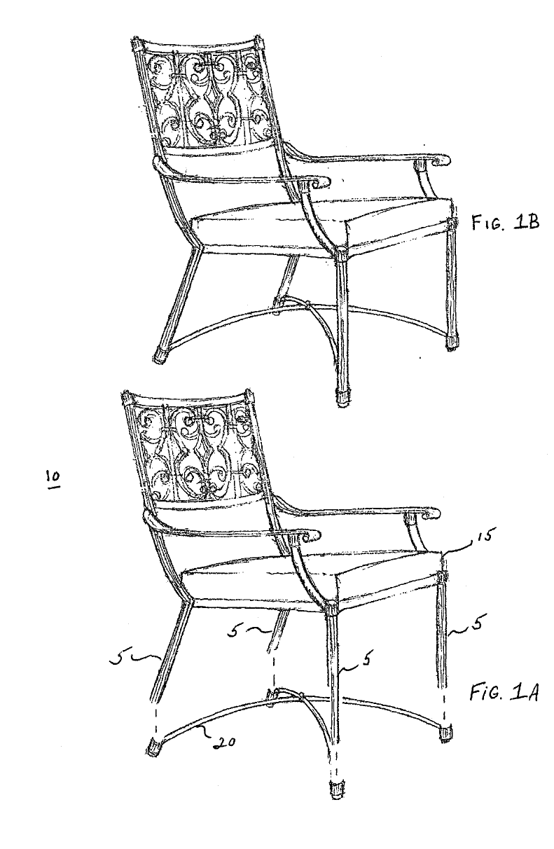

Referring to the figures, in which like numerals indicate like parts, and particularly to FIG. 1A, a chair embodiment of the present invention in which the chair portion 15 and its four legs 5 are detached from the stretcher assembly 20 is shown generally at 10. In its disassembled state, the chair portion 15 can be stacked with other chair portions in order to gain a space savings during shipment or storage of the chair. The stretcher assembly 20 could be stored or shipped separately from the chair portion as may be beneficial under the circumstances.

The configuration of a fully assembled chair embodiment of the present invention can be best seen in FIG. 1B.

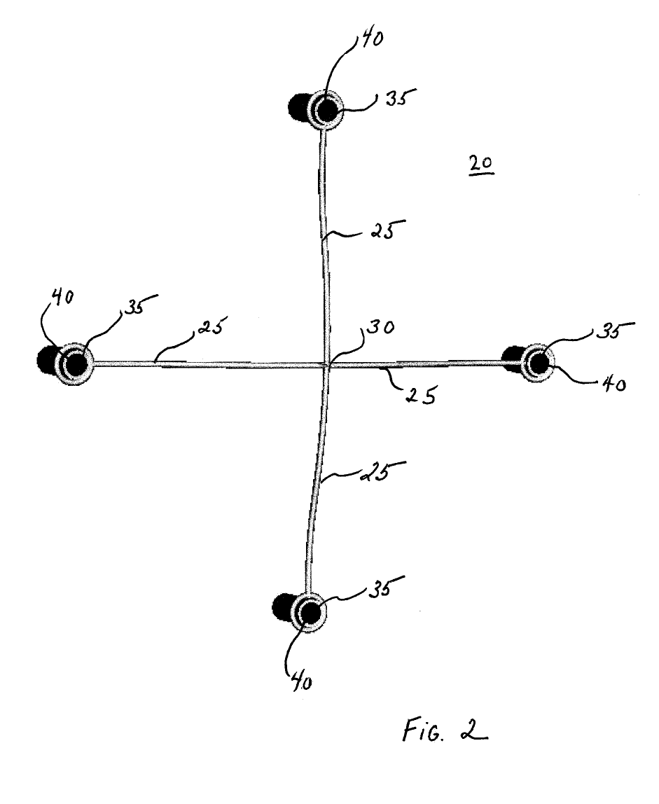

The configuration of a stretcher assembly of a chair embodiment of the present invention can be best seen in FIG. 2. In this figure, the stretcher assembly 20 is shown from a top perspective. The individual stretchers 25 are joined at a hub point 30 and at the free (or spoke) end of each stretcher 25 there is attached a leg extension 35. Each leg extension 35, in turn, has a longitudinal opening 40 which traverses its entire length.

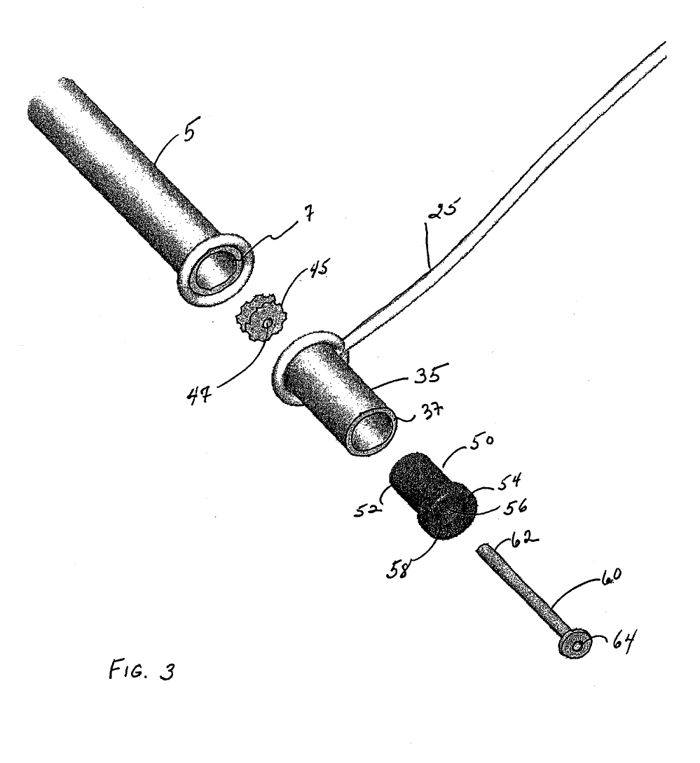

A partial exploded view of the stretcher assembly and chair portion of a chair embodiment of the present invention showing a chair leg 5, leg extension 35, stretcher 25, machined fastener 45, flanged glide 50 and screw fastener 60 can be best seen in FIG. 3. The shown detail is substantially identical and repeated at each leg 5 of the chair of the preferred embodiment.

As can be seen in FIG. 3, in a preferred embodiment both the chair leg 5 and leg extension 35 are generally cylindrical and hollow. Alternative embodiments of the present invention may, however, have non-cylindrical legs. In such embodiments, the leg extensions 35 and flange glide 50 would preferably, although not necessarily, have a cross-section to that closely matches that of the legs 5. The machined fastener 45 consists of what is commonly referred to as a “star fastener.” A star fastener is designed so that it can be easily inserted in a cylindrical opening but becomes embedded and offers great resistance when removal of the fastener is attempted. The machined fastener 45 has a threaded screw hole 47 which completely traverses it and is designed to mate with the screw fastener 60. The machined fastener 45 is essentially used as a “blind nut” that is inserted into the chair leg 5 and remains there to permit attachment of the stretcher assembly 20. Alternative embodiments can utilize many other types of fasteners designed to act as blind nuts, such as for example a welded threaded insert. In cases where the chair leg 5 is not hollow, the machined fastener 45 can be eliminated and replaced by a threaded screw hole drilled directly into the bottom of the leg 5 and having threads that match the screw fastener 60.

The leg extension 35 consists essentially of a relatively (in comparison with the leg 5) short hollow cylindrical part with an outside diameter that is preferably at least equal to the outside diameter of the leg 5. The end of the stretcher 25 is fixedly attached to the leg extension 35 by any convenient means.

The flanged glide 50 is preferably manufactured out of a solid rubber, plastic or other material suitable as the contact point between the chair and the floor. The flanged glide 50 is generally cylindrical and consists of an insertable end 52 and flanged end 54. The insertable end 52 of the flanged glide 50 has a diameter which allows it to fit snugly within the inside diameter of the leg extension 35. Alternatively, the flanged glide 50 could be equipped with external screw threads on the interface with the interior wall of the leg extension 35 and the leg extension 35 equipped with internal threads disposed to receive said external threads. The flanged end 54 of the flanged glide 50 has a diameter which is greater than the inside diameter of the leg extension 35 and thus prevents the entire flanged glide 50 from being inserted into the leg extension 35. The flanged glide 50 has a smooth (i.e. non threaded) longitudinal opening 56 which completely traverses it. The diameter of this longitudinal opening 56 is wide enough to permit the threaded portion 62 of the screw fastener 60 to fit inside and across it but is narrow enough to stop the head 64 of the screw fastener 60 from entering it. The flanged glide 50 also has an opening 58 which permits the head 64 of the screw fastener 60 to be completely recessed when all the parts are assembled.

To assemble all the parts, the machined fastener 45 is inserted into the leg 5. Next, the stretcher assembly 20 is placed so that the stretcher 25 and leg extension 35 lie directly against the bottom facing (or floor-facing) surface 7 of the leg 5. Next, the insertable end 52 of the flanged glide 50 is inserted into the leg extension 35 until the flanged end 54 of the flanged glide 50 contacts the bottom facing surface 37 of the leg extension 35. Finally, the screw fastener 60 is inserted through the longitudinal opening 56 of the flanged glide 50 until its threaded end 62 engages the threaded screw hole 47 of the machined fastener 45. To complete assembly, the screw fastener 60 is completely fastened until its entire head 64 is recessed into the flanged glide 50 and the entire assembly is secured. The same steps are then repeated at each leg of the chair.

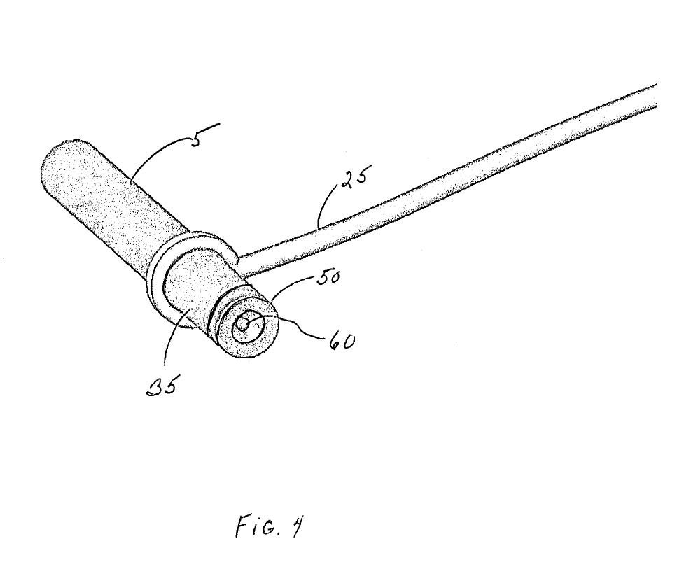

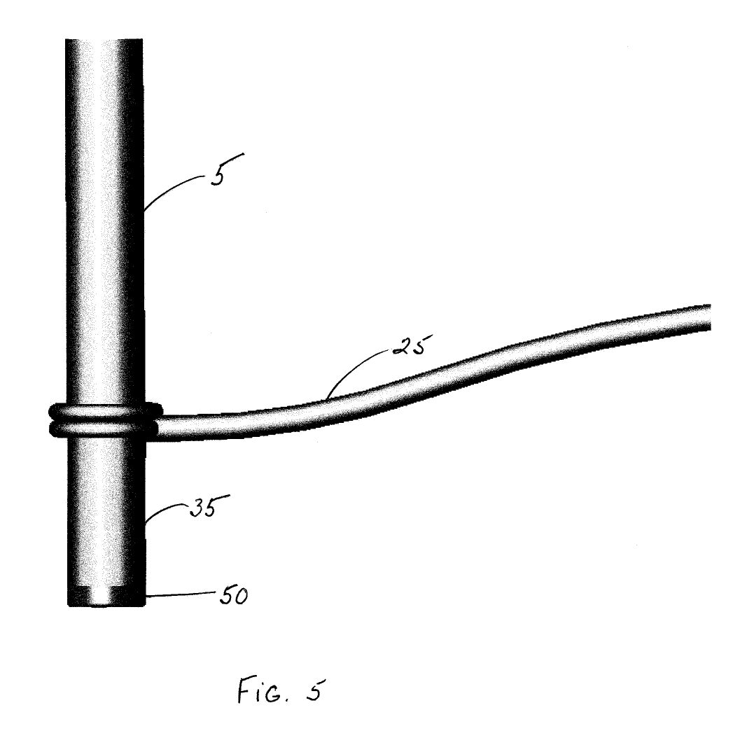

Partial isometric and front views of the stretcher assembly and chair portion of a chair embodiment of the present invention showing a chair leg, leg extension, stretcher, machined fastener, flanged glide and screw fastener can be seen in FIG. 4 and FIG. 5.

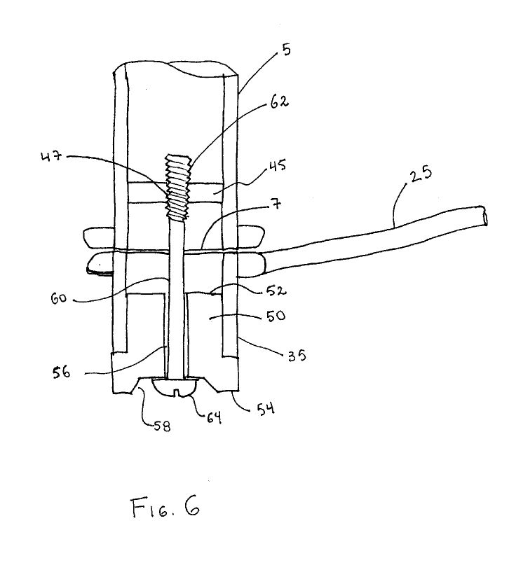

For further clarity, FIG. 6 provides a cross section of the partial front view of the stretcher assembly and chair portion of a chair embodiment of the present invention showing a chair leg, leg extension, stretcher, machined fastener, flanged glide and screw fastener in assembled condition.

Accordingly, it will be understood that the preferred embodiment of the present invention has been disclosed by way of example and that other modifications and alterations may occur to those skilled in the art without departing from the scope and spirit of the specific disclosure herein.

1. A removable leg stretcher assembly for use with legged furniture, comprising:
a plurality of elongated stretchers each having a distal and a proximal end;
a plurality of leg extensions, wherein each of said leg extensions is connected to the distal end of a corresponding one of said stretchers;
a hub point connecting the proximal ends of said stretchers;
means for removably attaching said leg stretcher assembly to the legs of said legged furniture.

2. The removable leg stretcher assembly of claim 1 wherein said means for removably attaching said leg stretcher assembly to the legs of said legged furniture comprise:
leg extension openings traversing the entire length of each of said leg extensions;
threaded screw-receiving attachment means located on the floor-facing surface of each of said furniture legs;
glides, wherein said glides are adapted so as to fit inside each of said leg extension openings but prevented from completely being inserted into said leg extension openings;
unthreaded screw holes traversing the entire length of each of said glides; and,
screw fasteners, wherein each of said screw fasteners is adapted to be inserted through said unthreaded screw holes and engage said threaded screw-receiving attachment means.

3. The removable leg stretcher assembly of claim 2 wherein said threaded screw-receiving attachment means comprise threaded holes.

4. The removable leg stretcher assembly of claim 2 wherein said threaded screw-receiving attachment means comprise machined fasteners adapted to be inserted through, or attached to, the floor-facing surface of each of said furniture legs.

5. The removable leg stretcher assembly of claim 4 wherein said machined fasteners are star fasteners.

6. The removable leg stretcher assembly of claim 4 wherein said machined fasteners are blind nuts.

7. The removable leg stretcher assembly of claim 2 wherein said glides are flanged.

8. The removable leg stretcher assembly of claim 2 wherein said glides are adapted to permit the head of said screw fasteners to be completely recessed upon installation.

9. The removable leg stretcher assembly of claim 1 wherein the number of said stretchers and said leg extensions is the same as the number of legs in said legged furniture.

10. A legged furniture article, comprising:
a base surface;
a plurality of legs interconnected with said base surface and extending downwardly therefrom; and
a removable leg stretcher assembly.

11. The legged furniture article of claim 10 wherein said legged furniture article is selected from the group of furniture articles consisting of: chairs, tables, ottomans, chaise lounges, cabinets and bookshelves.

12. The legged furniture article of claim 11 wherein said removable leg stretcher assembly comprises:
a plurality of elongated stretchers each having a distal and a proximal end;
a plurality of leg extensions, wherein each of said leg extensions is connected to the distal end of a corresponding one of said stretchers;
a hub point connecting the proximal ends of said stretchers;
means for removably attaching said leg stretcher assembly to the legs of said legged furniture article.

13. The legged furniture article of claim 12 wherein said means for removably attaching said leg stretcher assembly to the legs of said legged furniture article comprise:
leg extension openings traversing the entire length of each of said leg extensions;
threaded screw-receiving attachment means located on the floor-facing surface of each of said legged furniture article legs;
glides, wherein said glides are adapted so as to fit inside each of said leg extension openings but prevented from completely being inserted into said leg extension openings;
unthreaded screw holes traversing the entire length of each of said glides; and,
screw fasteners, wherein each of said screw fasteners is adapted to be inserted through said unthreaded screw holes and engage said threaded screw-receiving attachment means.

14. The legged furniture article of claim 13 wherein said threaded screw-receiving attachment means comprise threaded holes.

15. The legged furniture article of claim 13 wherein said threaded screw-receiving attachment means comprise machined fasteners adapted to be inserted through, or attached to, the floor-facing surface of each of said legged furniture article legs.

16. The legged furniture article of claim 15 wherein said machined fasteners are star fasteners.

17. The legged furniture article of claim 15 wherein said machined fasteners are blind nuts.

18. The legged furniture article of claim 13 wherein said glides are flanged.

19. The legged furniture article of claim 13 wherein said glides are adapted to permit the head of said screw fasteners to be completely recessed upon installation.

20. The legged furniture article of claim 12 wherein the number of said stretchers and said leg extensions is the same as the number of said plurality of legs in said legged furniture article.
